(19) United States
(12) Patent Application Publication
(10) Pub. No.: US 2010/0070987 A1
(43) Pub. Date: Mar. 18, 2010

(54) MINING VIEWER RESPONSES TO MULTIMEDIA CONTENT

(75) Inventors: Brian Scott Amento, Morris Plains, NJ (US); Alicia Abella, Morristown, NJ (US); Larry Stead, Upper Montclair, NJ (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/242,451

(22) Filed: Sep. 30, 2008

Related U.S. Application Data
(60) Provisional application No. 61/096,514, filed on Sep. 12, 2008.

(51) Int. Cl. H04H 60/33

(52) U.S. Cl. 725/10; 725/18; 725/19

(57) ABSTRACT

Viewers of a multimedia program are monitored to detect responses. Time data is stored with the responses and compared to responses from other viewers at the same time in the multimedia program. A viewer type is determined based on the responses. Further multimedia programs may be offered to the viewer based on the viewer type. Transducers and sensors placed within a viewing area may include, without limitation, audio sensors, video sensors, motion sensors, subdermal sensors, and biometric sensors.

### BACKGROUND

1. Field of the Disclosure

The present disclosure generally relates to multimedia content provider networks and more particularly to monitoring viewers of multimedia programs.

2. Description of the Related Art

Providers of multimedia content such as television, pay-per-view movies, and sporting events typically find it difficult to know the status of viewers while the multimedia content is displayed. In some cases, a viewer's reaction to a multimedia program may be obtained from a written questionnaire. It may be difficult to convince a representative sample of viewers to provide accurate and thorough answers to written questionnaires.

### BRIEF DESCRIPTION OF THE DRAWINGS

FIG. 1 illustrates a representative Internet Protocol Television (IPTV) architecture for mining viewer responses to multimedia content in accordance with disclosed embodiments;

FIG. 2 is a block diagram of selected components of an embodiment of a remote control device adapted to monitor a viewer's reactions to a multimedia program;

FIG. 3 is a block diagram of selected components of a data capture unit for monitoring and transmitting a viewer's reactions to a multimedia program;

FIG. 4 is a block diagram of selected elements of an embodiment of a set-top box (STB) from FIG. 1 for processing a viewer's responses to a multimedia program;

FIG. 5 illustrates a viewer in a viewing area that is watching a multimedia program while being monitored by a plurality of sensors (e.g., transducers) to detect a plurality of viewer responses to a multimedia program;

FIG. 6 illustrates a screen shot with a virtual environment including a plurality of avatars that correspond to viewers whose reactions are monitored in accordance with disclosed embodiments;

FIG. 7 illustrates a screen shot with viewer response data from multiple viewers; and

FIG. 8 is a flow chart with selected elements of a disclosed embodiment for mining viewer responses to a multimedia program.

### DESCRIPTION OF THE EMBODIMENT(S)

In one aspect, embodied methods of mining viewer responses to a multimedia program include monitoring the viewer for a response, comparing the response to stored responses, characterizing a status of the viewer, and storing the status of the viewer. Monitoring the viewer may include detecting a level of eye movement indicative of a gaze status. In some embodiments, the method includes selecting further multimedia programs for offer to the viewer based on the stored status. The method may further include collecting a plurality of status conditions from a plurality of viewers, integrating the plurality of status conditions into a plurality of known status conditions, and comparing a stored status condition of the viewer to known status conditions. Based on the comparing, a viewer type may be assigned to the viewer. The viewer type may be used in predicting whether the viewer would enjoy a further program of multimedia content. Video data may be generated from a plurality of images captured from the user. Characterizing the viewer may be based on comparing the video data to predetermined video parameters. Comparing the video data to predetermined video parameters may help to determine whether the viewer is smiling or laughing. Comparing the video data to predetermined video parameters may also help determine whether the viewer is facing a display on which the multimedia program is presented. A color-coded implement such as a glove may be used by a viewer and analyzing the video data may include detecting and observing movement of the color-coded implement. Audio data may be captured from a viewing area and compared to predetermined audio parameters to characterize the viewer status. In some embodiments, audio signals may be generated using bone conduction microphones. The method may include estimating whether the viewer has a vocal outburst to a portion of the program by detecting magnitude changes of audio signals. The method may include generating motion data from monitoring the viewer and comparing the motion data to predetermined motion parameters. In addition, the method may include capturing biometric data from the viewer and comparing the biometric data to metric norms. The biometric data may include pulse rate, temperature, and other types of data and may be captured using a subdermal transducer.

In another aspect, a disclosed computer program product characterizes a viewer response to a multimedia content program. The computer program product includes instructions for detecting a viewer response to a portion of the multimedia content program, comparing the viewer response to stored responses, characterizing a status of the viewer based on the comparing, and storing the status of the viewer. Detecting the viewer response may be achieved through data captured from transducers that are placed within a viewing area that is proximal to the viewer. Further instructions are for collecting a plurality of status conditions from a plurality of viewers, integrating the plurality of status conditions into a plurality of known conditions, and comparing a portion of the stored plurality of status conditions from the viewer to the known status conditions of other viewers. A type may be assigned to the viewer based on the comparing, and instructions may predict whether the viewer will enjoy a further multimedia content program based on the assigned type. Further instructions monitor the viewer for a gaze status that indicates a level of eye movement and may estimate whether the viewer is paying attention to the program based on the gaze status. Further instructions generate video data from a plurality of video images captured from the viewer, compare the video data to predetermined video parameters, analyze the video data to determine whether the viewer is smiling or laughing, analyze the video data to determine whether the viewer is facing a display on which the multimedia content program is presented, generate audio data for a plurality of audio signals captured from a viewing area, compare the audio data to predetermined audio parameters, estimate whether the viewer has a vocal outburst by detecting changes in an audio level measured at the location, generate motion data from monitoring the viewer, compare the motion data to predetermined motion parameters, and capture biometric data from the viewer.

In still another aspect, a device is disclosed that has an interface for receiving data from a plurality of transducers in a data collection environment in which a multimedia content program is presented. The device may be a customer premises equipment (e.g., an STB). Data collected from the device may include audio data, video data, and biometric data such as pulse rate. A plurality of transducers may include subdermal transducers or bone conduction microphones. A processor within the disclosed device compares the collected data to known data and estimates a plurality of reactions. The processor associates a plurality of reactions with time data and predicts whether the viewer would enjoy a further multimedia content program based on the plurality of reactions.

In the following description, examples are set forth with sufficient detail to enable one of ordinary skill in the art to practice the disclosed subject matter without undue experimentation. It should be apparent to a person of ordinary skill that the disclosed examples are not exhaustive of all possible embodiments. Regarding reference numerals used to describe elements in the figures, a hyphenated form of a reference numeral refers to a specific instance of an element and an un-hyphenated form of the reference numeral refers to the element generically or collectively. Thus, for example, element 121-1 refers to an instance of an STB, which may be referred to collectively as STBs 121 and any one of which may be referred to generically as an STB 121. Before describing other details of embodied methods and devices, selected aspects of multimedia content provider networks that provide multimedia programs are described to provide further context.

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a large number of multimedia content channels (also referred to herein as “channels”), each occupying a different frequency band or frequency channel, through a coaxial cable, a fiber-optic cable, or a combination of the two. The bandwidth required to transport simultaneously a large number of multimedia channels may challenge the bandwidth capacity of cable-based networks. In these types of networks, a tuner within an STB, television, or other form of receiver is required to select a channel from the mixed signal for playing or recording. A user wishing to play or record multiple channels typically needs to have distinct tuners for each desired channel. This is an inherent limitation of cable networks and other mixed signal networks.

In contrast to mixed signal networks, IPTV networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies to distribute multimedia content. Instead of being associated with a particular frequency band, an IPTV television program, movie, or other form of multimedia content is a packet-based stream that corresponds to a particular network endpoint, e.g., an IP address and a transport layer port number. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an indication of a network endpoint that is associated with the desired channel.

IPTV may be implemented, at least in part, over existing infrastructure including, for example, a proprietary network that may include existing telephone lines, possibly in combination with CPE including, for example, a digital subscriber line (DSL) modem in communication with an STB, a display, and other appropriate equipment to receive multimedia content and convert it into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a user's CPE and a service provider's equipment. Bidirectional communication allows a service provider to deploy advanced features, such as VOD, pay-per-view, advanced programming information (e.g., sophisticated and customizable electronic program guides (EPGs)), and the like. Bidirectional networks may also enable a service provider to collect information related to a user's preferences, whether for purposes of providing preference-based features to the user, providing potentially valuable information to service providers, or providing potentially lucrative information to content providers and others.

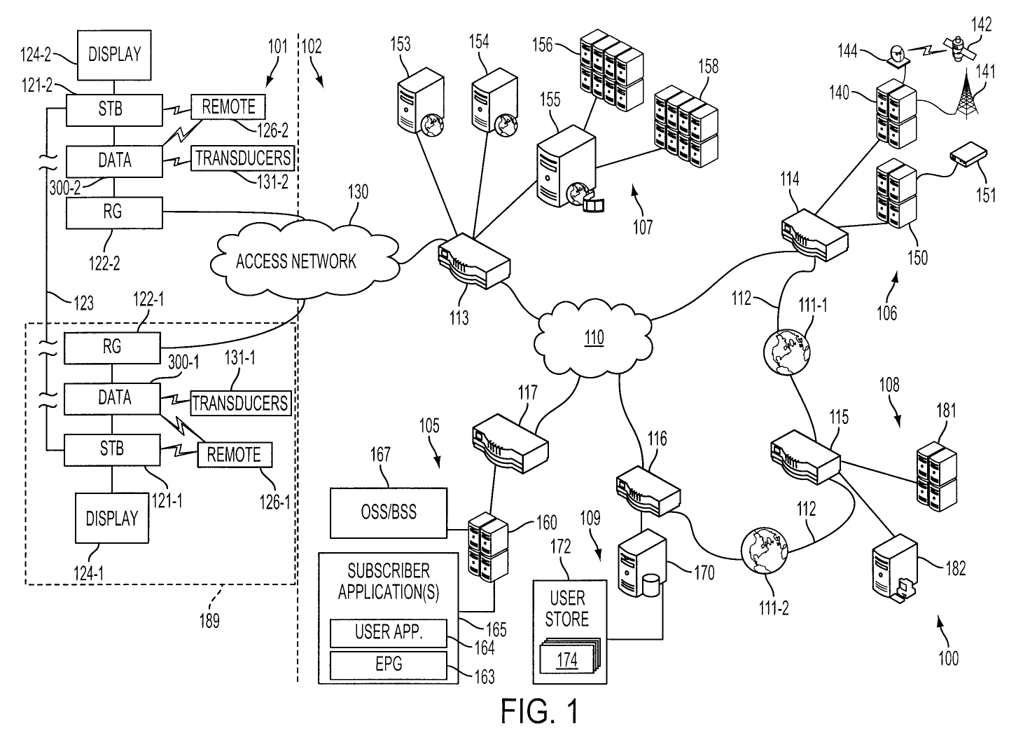

Referring now to the drawings, FIG. 1 illustrates selected aspects of a multimedia content distribution network (MCDN) 100 for providing remote access to multimedia content in accordance with disclosed embodiments. MCDN 100, as shown, is a multimedia content provider network that may be generally divided into a client side 101 and a service provider side 102 (a.k.a., server side 102). Client side 101 includes all or most of the resources depicted to the left of access network 130 while server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical cables that connect a subscriber's home or business to a local exchange. In these embodiments, the physical layer of access network 130 may include varying ratios of twisted pair copper cables and fiber optics cables. In a fiber to the curb (FTTC) access network, the last mile portion that employs copper is generally less than approximately 300 miles in length. In fiber to the home (FTTH) access networks, fiber optic cables extend all the way to the premises of the subscriber.

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

Access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content to users served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 may communicate over a public network 112, including, for example, Internet or other type of web-network where the public network 112 is signified in FIG. 1 by the World Wide Web icons 111.

As shown in FIG. 1, client side 101 of MCDN 100 depicts two of a potentially large number of client side resources referred to herein simply as client(s) 120. Each client 120, as shown, includes an STB 121, a residential gateway (RG) 122, a display 124, and a remote control device 126. In the depicted embodiment, STB 121 communicates with server side devices through access network 130 via RG 122.

As shown in FIG. 1, RG 122 may include elements of a broadband modem such as a DSL or cable modem, as well as elements of a firewall, router, and/or access point for an Ethernet or other suitable local area network (LAN) 123. In this embodiment, STB 121 is a uniquely addressable Ethernet compliant device. In some embodiments, display 124 may be any National Television System Committee (NTSC) and/or Phase Alternating Line (PAL) compliant display device. Both STB 121 and display 124 may include any form of conventional frequency tuner. Remote control device 126 communicates wirelessly with STB 121 using infrared (IR) or RF signaling. STB 121-1 and STB 121-2, as shown, may communicate through LAN 123 in accordance with disclosed embodiments to select multimedia programs for viewing.

As shown, RG 122 is communicatively coupled to data capture unit 300. In addition, data capture unit 300 is communicatively coupled to remote control device 126 and STB 121. In accordance with disclosed embodiments, data capture unit 300 captures video data, audio data, and other data from a viewing area to detect and characterize a viewer response to a multimedia program presented on display 124. In some embodiments, the data capture unit 300 includes onboard sensors (e.g., microphones) and detects a change in audio level to determine whether a viewer has an outburst in response to particular portions of a multimedia program. Data capture unit 300 may communicate wirelessly through a network interface to STB 121-1 and STB 121-2. In addition, data capture unit 300 may communicate using radio frequencies and other means with remote control device 126. As shown, RG 122-1, data capture unit 300-1, STB 121-1, display 124-1, remote control device 126-1, and transducers 131-1 are all included in viewing area 189. Data capture unit 300 receives viewer response data from transducers 131 which may be distributed around a viewing area (e.g., viewing area 189). In some embodiments, transducers 131 include subdermal sensors that may be implanted in a viewer. Transducers 131 may also include, as examples, bone conduction microphones, temperature sensors, pulse detectors, cameras, microphones, light level sensors, viewer presence detectors, motion detectors and mood detectors. Additional sensors may be placed near a viewer or under a view (e.g., within a chair) to determine whether a viewer shifts, acts fidgety, or is horizontal during the display of a multimedia program. Any one or more of transducers 131 may be incorporated into any combination of remote control device 126, data capture unit 300, display 124, RG 122, or STB 121 or other such components that may not be depicted in FIG. 1.

In IPTV compliant implementations of MCDN 100, clients 120 are configured to receive packet-based multimedia streams from access network 130 and process the streams for presentation on displays 124. In addition, clients 120 are network-aware resources that may facilitate bidirectional-networked communications with server side 102 resources to support network hosted services and features. Because clients 120 are configured to process multimedia content streams while simultaneously supporting more traditional web-like communications, clients 120 may support or comply with a variety of different types of network protocols including streaming protocols such as real-time transport protocol (RTP) over user datagram protocol/internet protocol (UDP/IP) as well as web protocols such as hypertext transport protocol (HTTP) over transport control protocol (TCP/IP).

The server side 102 of MCDN 100 as depicted in FIG. 1 emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down linked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. As shown, live acquisition server 140 is communicatively coupled to encoder 189 which, prior to transmission, encodes acquired content using for example, MPEG-2, H.263, MPEG-4, H.264, a Windows Media Video (WMV) family codec, or another suitable video codec.

Content delivery resources 107, as shown in FIG. 1, are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content according to the network communication protocol stack in use. These data packets are then transmitted across a network to a receiver (e.g., STB 121 of client 120), where the content is parsed from individual packets and re-assembled into multimedia content suitable for processing by a decoder.

User requests received by content delivery server 155 may include an indication of the content that is being requested. In some embodiments, this indication includes a network endpoint associated with the desired content. The network endpoint may include an IP address and a transport layer port number. For example, a particular local broadcast television station may be associated with a particular channel and the feed for that channel may be associated with a particular IP address and transport layer port number. When a user wishes to view the station, the user may interact with remote control device 126 to send a signal to STB 121 indicating a request for the particular channel. When STB 121 responds to the remote control signal, the STB 121 changes to the requested channel by transmitting a request that includes an indication of the network endpoint associated with the desired channel to content delivery server 155.

Content delivery server 155 may respond to such requests by making a streaming video or audio signal accessible to the user. Content delivery server 155 may employ a multicast protocol to deliver a single originating stream to multiple clients. When a new user requests the content associated with a multicast stream, there may be latency associated with updating the multicast information to reflect the new user as a part of the multicast group. To avoid exposing this undesirable latency to a user, content delivery server 155 may temporarily unicast a stream to the requesting user. When the user is ultimately enrolled in the multicast group, the unicast stream is terminated and the user receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations. To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including RTP, real-time control protocol (RTCP), file transfer protocol (FTP), and real-time streaming protocol (RTSP), as examples.

In some embodiments, client-facing switch 113 routes multimedia content encapsulated into IP packets over access network 130. For example, an MPEG-2 transport stream may be sent, in which the transport stream consists of a series of 188-byte transport packets, for example. Client-facing switch 113, as shown, is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming subscriber and/or billing information, client gateway 153 may allow STB 121 access to IPTV content, VOD content, and other services. If client gateway 153 cannot verify subscriber information (i.e., user information) for STB 121, for example, because it is connected to an unauthorized local loop or RG, client gateway 153 may block transmissions to and from STB 121 beyond the private access network 130. OSS/BSS server 181 hosts operations support services including remote management via a management server 182. OSS/BSS resources 108 may include a monitor server (not depicted) that monitors network devices within or coupled to MCDN 100 via, for example, a simple network management protocol (SNMP).

MCDN 100, as depicted, includes application resources 105, which communicate with private network 110 via application switch 117. Application resources 105 as shown include an application server 160 operable to host or otherwise facilitate one or more subscriber applications 165 that may be made available to system subscribers. For example, subscriber applications 165 as shown include an EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a user, who may be a subscriber to a service provided by MCDN 100. For example, in accordance with disclosed embodiments, user application 164 may be an application that processes data collected from monitoring one or more viewers, compares the processed data to data collected from other users, assigns a viewer type to each of the viewers, and recommends or provides multimedia content to the viewers based on the assigned types. User application 164, as illustrated in FIG. 1, emphasizes the ability to extend the network's capabilities by implementing a network-hosted application. Because the application resides on the network, it generally does not impose any significant requirements or imply any substantial modifications to client 120 including STB 121. In some instances, an STB 121 may require knowledge of a network address associated with user application 164, but STB 121 and the other components of client 120 are largely unaffected.

As shown in FIG. 1, a database switch 116, as connected to applications switch 117, provides access to database resources 109. Database resources 109 include a database server 170 that manages a system storage resource 172, also referred to herein as user store 172. User store 172, as shown, includes one or more user profiles 174 where each user profile includes account information and may include preferences information that may be retrieved by applications executing on application server 160 including user applications 165.

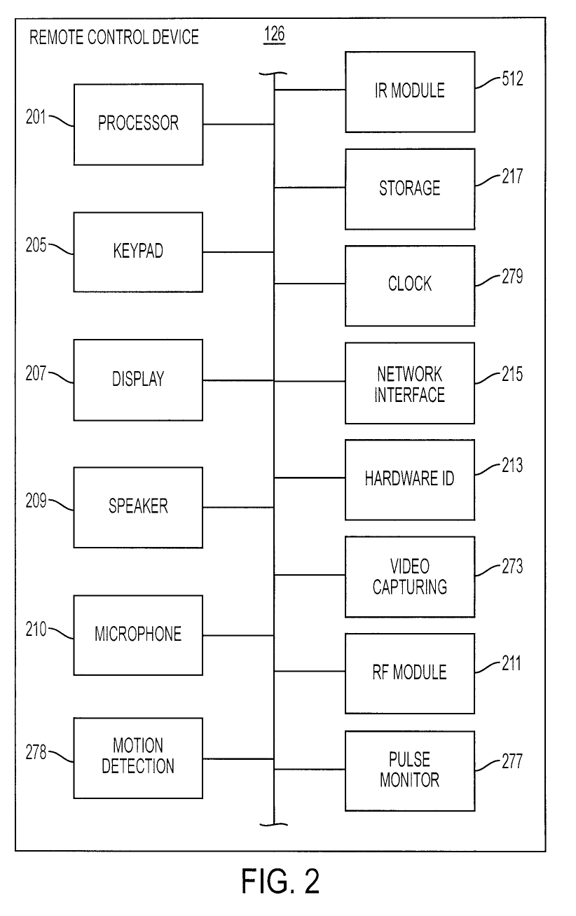

FIG. 2 depicts selected components of remote control device 126, which may be identical to or similar to remote control device 126-1 and remote control device 126-2 from FIG. 1. Remote control device 126 includes IR module 512 for communication with an STB (e.g., STB 121-1 from FIG. 1), a data collection module (e.g., data collection module 300-1 from FIG. 1), or a display (e.g., a display 124-1 from FIG. 1). Processor 201 communicates with special purpose modules including, as examples, video capturing module 273, pulse monitor 277, motion detection module 278, and IR module 512. Keypad 205 receives user input to change channels on an STB, a television display, or other device. Keypad 205 may also receive user input that is a request for entry of a sketch annotation or a selection of an on-screen item, as examples. Display 207 may provide the user of remote control device 126 with an EPG or with options for selecting programs. In some embodiments display 207 includes touch screen capabilities. Speaker 209 is optional and provides a user (e.g., a viewer) of remote control device 126 with audio output for a multimedia program or provides a user feedback regarding selections made to keypad 205, for example. Microphone 210 may receive speech input used with voice recognition processors for selecting programs from an EPG or providing instructions through remote control device 126 to other devices. In accordance with disclosed embodiments, microphone 210 detects audio input from a viewer to estimate the response of the viewer to a particular portion of a multimedia program. In some embodiments, audio data detected by microphone 210 may be processed and forwarded over IR module 512 or RF module 211 to a data capture unit (e.g., data capture unit 300 from FIG. 1) or a network-based device for determining a user reaction to the multimedia program. Motion detection module 278 may include infrared capabilities and video processing capabilities to detect presence information and a level of motion for a viewer.

In operation, expected responses may be compared to monitored responses. For example, if during a football game, it is known by a provider network that a touchdown is scored by the Oilers football team, and motion detection module 278 detects a high-level of motion from a user, processor 201 may determine that the user of remote control device 126 is an Oilers fan. In this way, the user is assigned a type (i.e., Oilers fan). If a network knows that other Oilers fans like certain programming, this programming may be offered to the user of remote control device 126 at a later time. As shown in FIG. 1, pulse monitor 277 may monitor or estimate a pulse of the user of the remote control device 126. Video capturing module 273 may capture video data to estimate motion or presence information. For example, video data may be processed to detect a level of eye movement to determine whether a user is gazing at a display. In addition, video data captured using video capturing module 273 may be used to determine whether a user is laughing, smiling, angry, asleep, or bored. If video data captured using video capturing module 273 shows a user has his or her head turned to the side, it may be determined that the user of remote control device 126 is not watching a display.

As shown in FIG. 2, hardware identification (ID) module 213 is a network unique number or sequence of characters for identifying remote control device 126. Network interface 215 provides capabilities for remote control device 126 to communicate over a WiFi network, LAN, intranet, Internet, or other network. Clock module 279 provides timing information that is associated with data detected by motion detection module 278, pulse monitor 277, and video capturing module 273. Motion detection module 278 may include accelerometers or other similar sensors that detect the motion of remote control device 126. If a user is excited, the accelerometers may detect shaking motions, for example. Storage 217 may include nonvolatile memory, disk drive units, read-only memory, random access memory, solid-state memory, and other types of memory for storing motion detection data, video data, pulse data, and other such data. Storage 217 may also store instructions executed by processor 201 and other modules.

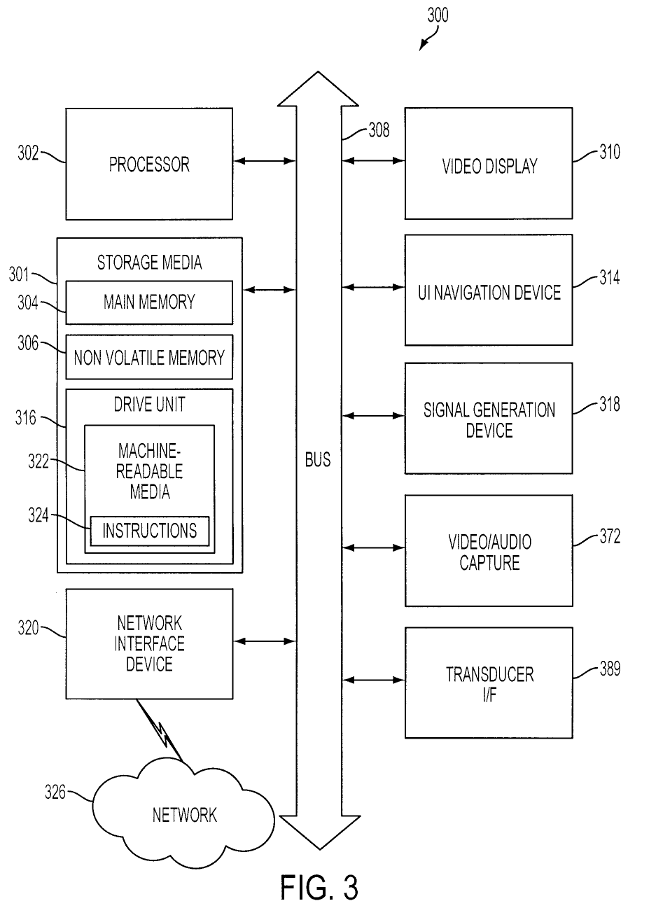

FIG. 3 depicts selected elements of a data capture unit 300, which may be identical to or similar to data capture unit 300 from FIG. 1. As shown, data capture unit 300 includes bus 308 for providing communication between and among other elements including processor 302. Optional video display 310 may provide status information to permit a user to determine whether data capture unit 300 is operating correctly, for example. An embodiment of video display 310 may indicate a series of bars with pixels illuminated based on an audio level. A user may glance at video display 310 to determine in real-time whether data capture unit 300 is operating correctly to capture audio data. In other embodiments, video display 310 may be used to configure which data is captured by data capture unit 300. For example, a user may use video display 310, which may be a touch screen display, to select whether video data is captured (for example through video/audio capture module 372), whether audio data is captured, or whether data from certain transducers is captured through transducer interface 389. Signal generation device 318 may communicate wirelessly with STBs or transducers. For example, data capture unit 300 may send acknowledgments to remote transducers to inform the transducers that signals have been successfully received over transducer interface 389. User interface navigation device 314, in some embodiments, includes the ability to process keyboard information, mouse information, and remote control device inputs to permit a user to configure data capture unit 300 as desired.

As shown, network interface device 320 communicates with network 326 which may include elements of access network 130 from FIG. 1. Through network interface device 320, data capture unit 300 may send viewer response data to a network-based analysis tool for determining a viewer response to a multimedia program. As shown, storage media 301 includes main memory 304, nonvolatile memory 306, and drive unit 316. Drive unit 316 includes machine-readable media 322 with instructions 324. Instructions 324 include computer readable instructions accessed and executed by processor 302 and, in some embodiments, executed by other modules. Instructions 324 may include instructions for detecting a viewer response to a portion of a multimedia program using data captured from transducers that are in communication with transducer interface 389. Transducers in communication with transducer interface 389 may be placed in a viewing area in which data capture unit 300 operates. Further instructions 324 may be for comparing viewer responses to stored responses and characterizing a viewer status. Instructions 324 may enable processor 302, using video and audio data captured from video/audio capture module 372 and external transducers, to monitor a viewer for responses to portions of the multimedia program. Further instructions compare the responses to stored responses and characterize a viewer status based on the comparing. In some embodiments, data capture unit 300 initiates a training sequence to establish baseline reactions that are added to storage media 301 as stored responses. For example, users may be presented with a sequence on video display 310 that asks for examples of laughing, smiling, excited outburst, and the like. Further instructions 324 store viewer reactions measured in response to having the viewer laugh, smile, and present an excited outburst. In some embodiments, training is not necessary and data capture unit 300 uses stored responses initially programmed by developers or otherwise downloaded. Such stored responses may also be updated over network interface device 320.

In some embodiments, a plurality of viewer responses from remote viewers is received over network interface device 320 from, for example, a service provider network (e.g., MCDN 100 from FIG. 1). Viewer response is detected and compared to the plurality of viewer responses of the remote viewers. A status of the local viewer (i.e., local to data capture unit 300) is characterized based on the comparing and the characterized status is stored in one or more elements of storage media 301. In some embodiments, processor 302 executes instructions 324 for integrating a plurality of status conditions from the remote viewers. For example, over network interface device 320, data capture unit 300 may receive external data that indicates that 53 other remote viewers are excited at a given time (e.g., during an Oilers touchdown). If processor 302 knows that at that given time, the Oilers scored a touchdown, processor 302 may determine that the 53 remote viewers are Oilers fans. If processor 302 determines that the viewer proximal to data capture unit 300 (i.e., the local viewer) is not excited at the given time, processor 302 (executing instructions 324) may determine that the local viewer is not a fan of the Oilers.

In some embodiments, instructions 324 include instructions for monitoring whether a viewer has a level of eye movement associated with a gaze status. For example, video data captured from video/audio capture module 372 may be analyzed to determine whether the whites of the viewer's eyes are visible. Criteria for determining whether the whites of the viewer's eyes are visible may be stored as video parameters in storage media 301. In addition, the video data may be analyzed to determine how often the viewer turns his or her head during a particular portion of a multimedia program. Based on whether the viewer is determined to have a gaze status, instructions 324 may estimate whether the viewer is paying attention to a multimedia program. If the multimedia program is a commercial, gaze status information may be used to determine advertising revenue to be charged. For example, if 90% of an audience is paying attention to a commercial based on gaze status information, a service provider network (e.g., MCDN 100) may charge an advertiser accordingly. Such gaze information may be uploaded to a service provider network through network interface device 320 over network 326.

Although the above example includes determining whether the viewer has a gaze status, processor 302 may execute other instructions 324 for determining other responses from the viewer. For example, instructions may determine whether a viewer is smiling or laughing. In addition, instructions 324 may include video parameters for determining whether a viewer is having a vocal outburst. In such cases, an audio level of an audio input may be analyzed that is detected from a microphone that is integrated into video/audio capture module 372 or remote from data capture unit 300. If an audio level has a sudden, short-lived increase, processor 302 may determine that a viewer had a vocal outburst.

Predetermined audio parameters may be stored in storage media 301 to enable instructions 324 to estimate a viewer response to a program. If an audio level is determined to be abnormally low by comparing local conditions to predetermined audio parameters, processor 302 (by executing instructions 324) may determine that a viewer is not paying attention to the program. In such cases, it may be determined that the viewer simply has a multimedia program on for background entertainment or has fallen asleep.

Further instructions 324 are for capturing or processing biometric data from the viewer. For example, a pulse monitor may transmit pulse data over transducer interface 389, which may then be used by processor 302 (executing instructions 324) to determine whether a viewer is excited during a portion of a multimedia program.

In some embodiments, motion data is detected and analyzed by processor 302. Motion transducers remote from data capture unit 300 may provide motion data over transducer interface 389, and the motion data may be compared to predetermined motion parameters stored on storage media 301. In some embodiments, background information is subtracted from a video signal as captured by video/audio capture module 372. In addition, a torso of a viewer may be subtracted by a motion detection subroutine (not depicted) and the remaining portion of the viewer, which includes the viewer's arms, may be analyzed to determine whether the viewer's arms are moving. After instructions 324 determine the status of the viewer, the status may be associated with timing information and stored to storage media 301. The stored status information including the timing information may later be analyzed and compared to known program data to determine whether a user enjoyed certain portions of the program. Such processing may be performed onboard or local to data capture unit 300, or may be uploaded to a content provider or other entity for processing.

Based on responses detected from the viewer, instructions 324 may assign a type for the viewer and predict whether the viewer would enjoy a further multimedia program based on the assigned type. For example, if a viewer has reacted wildly during every Oilers touchdown and the viewer type is determined to be an “Oilers fan,” future pay-per-view Oilers games or merchandise may be offered to the viewer.

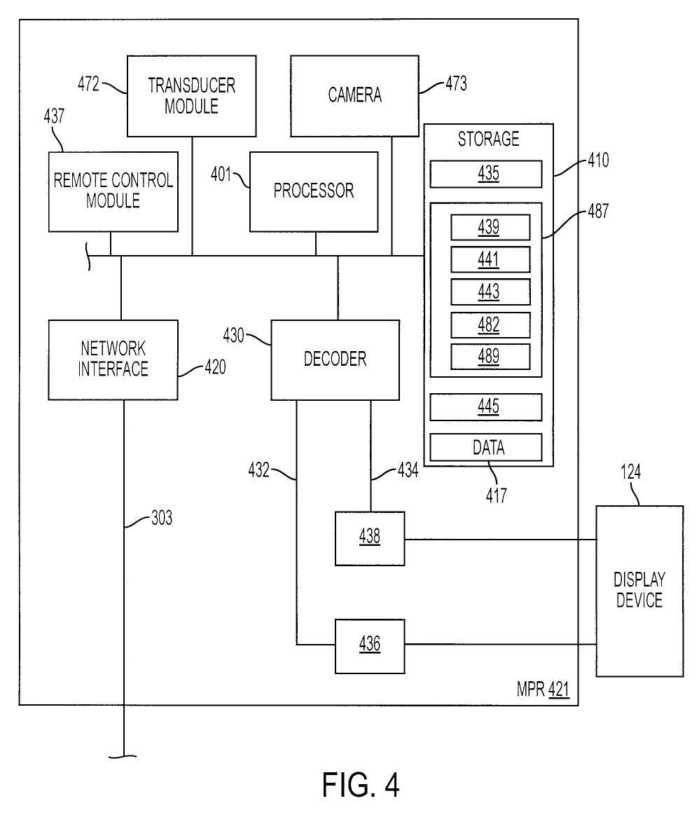

Referring now to FIG. 4, a block diagram illustrates selected elements of an embodiment of a multimedia processing resource (MPR) 421. MPR 421 may be an STB or other localized equipment for providing a user with access in usable form to multimedia content such as digital television programs. In this implementation, MPR 421 includes a processor 401 and general purpose storage 410 connected to a shared bus. A network interface 420 enables MPR 421 to communicate with LAN 303 (e.g., LAN 123 from FIG. 1). An integrated audio/video decoder 430 generates native format audio signals 432 and video signals 434. Signals 432 and 434 are encoded and converted to analog signals by digital-to-analog (DAC)/encoders 436 and 438. The output of DAC/encoders 436 and 438 is suitable for delivering to an NTSC, PAL, or other type of display device 124. Network interface 420 may also be adapted for receiving information from a remote hardware device, such as transducer data, viewer response data, and other input that may be processed or forwarded by MPR 421 to determine a viewer to a multimedia program. Network interface 420 may also be adapted for receiving control signals from a remote hardware device (e.g., remote control device 126 from FIG. 2) to control playback of multimedia content transmitted by CPE 310. Remote control module 437 processes user inputs from remote control devices and, in some cases, may process outgoing communications to two-way remote control devices.

As shown, general purpose storage 410 includes non-volatile memory 435, main memory 445, and drive unit 487. Data 417 may include user specific data and other information used by MPR 421 for providing multimedia content and collecting user responses. For example, viewer's login credentials, preferences, and known responses to particular input may be stored as data 417. As shown, drive unit 487 includes collection module 439, processing module 441 recognition module 482, recommendation module 443, and reaction module 489. Collection module 439 may include instructions for collecting viewer responses from external devices (e.g., data capture unit 300 from FIG. 3) or from transducers local to MPR 421, for example camera 473. Processing module 441 may use received data collected by collection module 439 for estimating a viewer response to a multimedia program and assigning a viewer type to the viewer based on the responses. Recognition module 482 may include computer instructions for recognizing a particular viewer and accessing known responses for that viewer during processing to characterize a response to a multimedia program. For example, recognition module 482 may be adapted to process video data captured from camera 473 or audio data to determine whether a viewer is known and whether any store data is associated with the viewer. Reaction determination module 489 processes received responses from the viewer and characterizes the reaction. For example, if an audio level is monitored and detected to have a significant increase at a time in a program known to have a touchdown, for example, reaction determination module 489 may determine that the viewer has had a vocal outburst. Transducer module 472 processes data received from internal and external transducers to provide data used for estimating a viewer response.

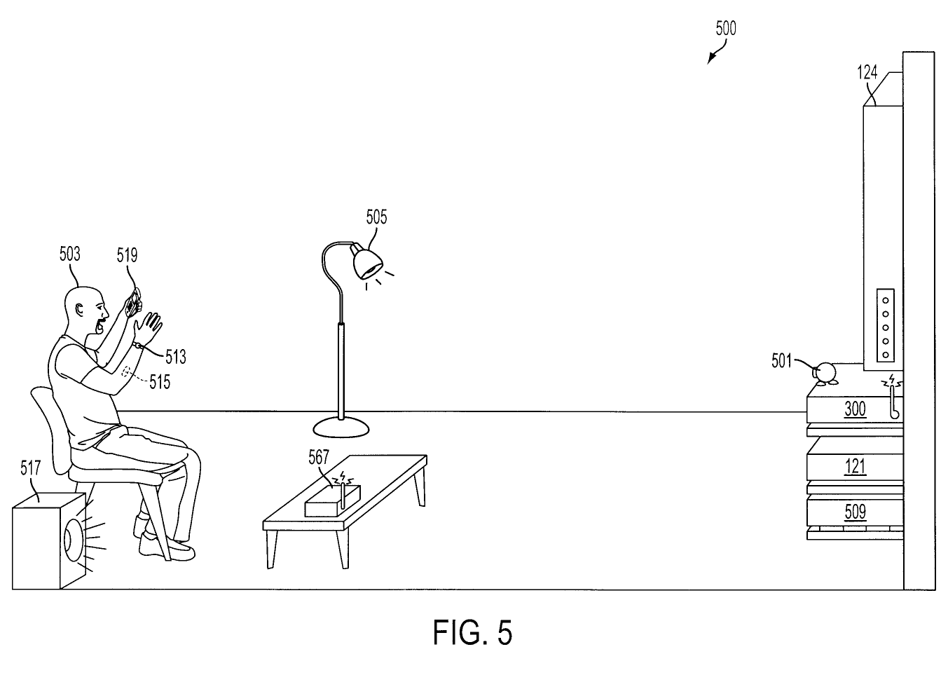

FIG. 5 depicts local viewing area 500 which includes a viewer 503 that is watching a multimedia program presented on display 124 with an audio portion produced by stereo 509 which provides audio output signals to speaker 517. Data capture unit 300 may be identical to or similar to data capture unit 300 from FIG. 3. As shown, data capture unit 300 includes audio/video module 501 for capturing audio and video data from viewing area 500. Data capture unit 300 may be communicatively coupled to stereo 509 for determining an audio level through encoded signals rather than from detecting an audio level. If an audio level is low, a determination may be made that viewer 503 is uninterested in the multimedia program presented on display 124. In addition, lamp 505 may be communicatively coupled to data capture unit 300 to provide input, through encoded signals, regarding a level of light output. The level of light output may be processed with other data collected by data capture unit 300 to determine a viewer response or interest level to the multimedia program presented on display 124. STB 121 is an example of MPR 421 from FIG. 4 and may be identical to or similar to STB 121 from FIG. 1. In the depicted embodiment, STB 121 is communicatively coupled to display 124 and stereo 509 to process signals received from a service provider network (e.g., MCDN 100 from FIG. 1) to permit presentation of video and audio components of a multimedia program in the viewing area 500.

Data capture unit 300 is communicatively coupled to remote transducer module 567. In accordance with disclosed embodiments, remote transducer module 567 may capture video, audio, and other data from viewer 503 and viewing area 500 and relay the data to data capture unit 300 or other components for processing. As shown, viewer 503 is monitored by subdermal sensor 515 which may capture biometric data including pulse data, motion data, temperature data, stress data, audio data, and mood data for viewer 503. The subdermal sensor 515 communicates with remote transducer module 567 or directly with data capture unit 300 to provide data indicative of viewer responses to the multimedia program. Remote control device 519, as shown, is held by viewer 503 and may be identical to or similar to remote control device 126 from FIG. 1. In some embodiments, remote control device 519 includes sensors for capturing audio data, video data, and biometric data. For example, remote control device 519 may capture pulse data and temperature data from a viewer. In addition, remote control device 519 may be adapted and enabled to detect vocal outbursts from viewer 503. Remote control device 519 may be used to control settings on remote transducer module 567 and data capture module 300. In addition, remote control device 519 may be enabled for controlling and providing user input to display 124, STB 121, and stereo 509. Attached to the wrist of viewer 503 is transducer 513. Transducer 513 may also capture biometric data from viewer 503 and detect motion and arm movements from viewer 503. Data collected from remote control device 519, transducer 513, subdermal sensor 515, remote transducer module 567, and data capture unit 300 may be processed and analyzed to determine viewer responses to the multimedia program. The viewer responses may be integrated and analyzed to determine a viewer status. A plurality of viewer's statuses (i.e., status conditions) may be associated with timing information, accumulated, and compared to predetermined data. In some embodiments, the predetermined data is collected from other viewers and may include expected values. For example, a viewer may be expected to be sad during a certain portion of a multimedia program. This expectation made be from observing that other viewers were sad during that portion of the program or from data from a movie producer, for example, that the particular portion of the program was intended to be sad. Using collected viewer responses and viewer statuses, a viewer type may be assigned. For example, the viewer may be determined to be insensitive, a sports fan, a Democrat, a Republican, a softy, or an Oilers fan, depending on the type of data collected.

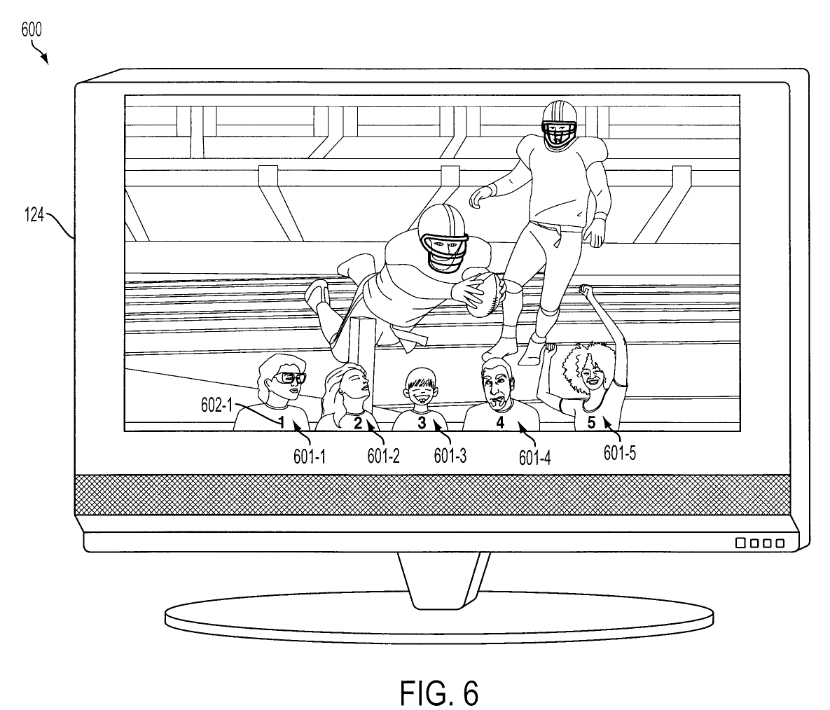

FIG. 6 illustrates viewing area 600 that includes display 124 that has a screen shot of football action. Viewing area 600 may be viewing area 500 (FIG. 5). In addition, display 124 includes a virtual environment with social interactive aspects that include character-based avatars 601. Each avatar 601 corresponds to a viewer of the football action. Viewers may all be located in viewing area 600 or may be located remote from viewing area 600. In accordance with same disclosed embodiments, avatars 601 provide realistic, synthetic versions of viewers. Transducers and other input devices such as cameras may detect motion, emotions, reactions, and the like from viewers and each avatar 601 may be programmed to track such actions from the viewers. For example, STB 121 (FIG. 1) may receive animation input data from transducers 131 (FIG. 1). As shown, avatar 601-1 includes avatar identifier 602-1 which simulates a jersey number worn by the avatar. As intended to be depicted in the screenshot, avatar 601-1 may be bored, avatar 601-2 appears to be asleep, avatar 601-3 appears to be laughing, avatar 601-4 appears to be unhappy, and avatar 601-5 appears to be happy, having raised hands, apparently in reaction to a touchdown being scored in the multimedia program. As shown in FIG. 6, avatars 601 are updated using viewer responses collected in accordance with disclosed embodiments.

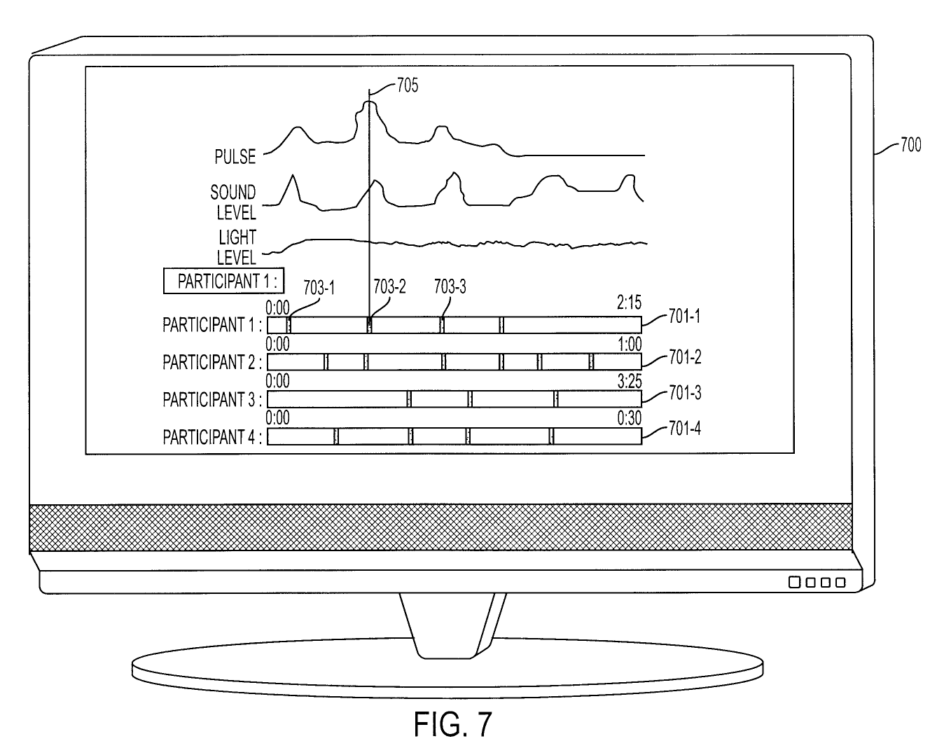

FIG. 7 illustrates select examples of viewer data that is collected in accordance with disclosed embodiments. As shown, the viewer data is presented on display 700, which may be identical to or similar to display 124 (FIG. 1). As shown, participant 701-1 corresponds to avatar 601-1 in FIG. 6. Similarly, participant 701-2 corresponds to avatar 601-2, participant 701-3 corresponds to avatar 601-3, and participant 701-4 corresponds to avatar 601-4. At time 705, participant 701-1 appears to have had an elevated pulse and an elevated sound level. In accordance with disclosed embodiments, a viewer reaction 703-2 is recorded as a shaded area in the graphic associated with participant 701-1. A similar shaded area appears at time 705 for participant 701-2. The data associated with participant 701-2 may include predetermined data or stored data that is used to determine a viewer type for participant 701-1. Because participant 701-1 has an outburst or reaction similar to participant 701-2 at time 705, participant 701-1 and participant 701-2 may have similar interests. Indeed, participant 701-1 has another reaction 703-3 which corresponds to a similar reaction of participant 701-2 at the same time. If a processing module analyzes reactions from participant 701-1 against reactions from participant 701-2 and the multimedia program is known to be a football game, a processing module (e.g., processing module 441 from FIG. 4) may postulate that participant 701-2 and 701-1 are fans of the same team. This is because three viewer reactions are recorded (e.g., viewer reaction 703-2) at the same time for both participant 701-2 and 701-1. As shown, participant 701-2 does not have a reaction that corresponds to reaction 703-1. This may suggest that participant 701-2 was not paying attention to the football game at that time.

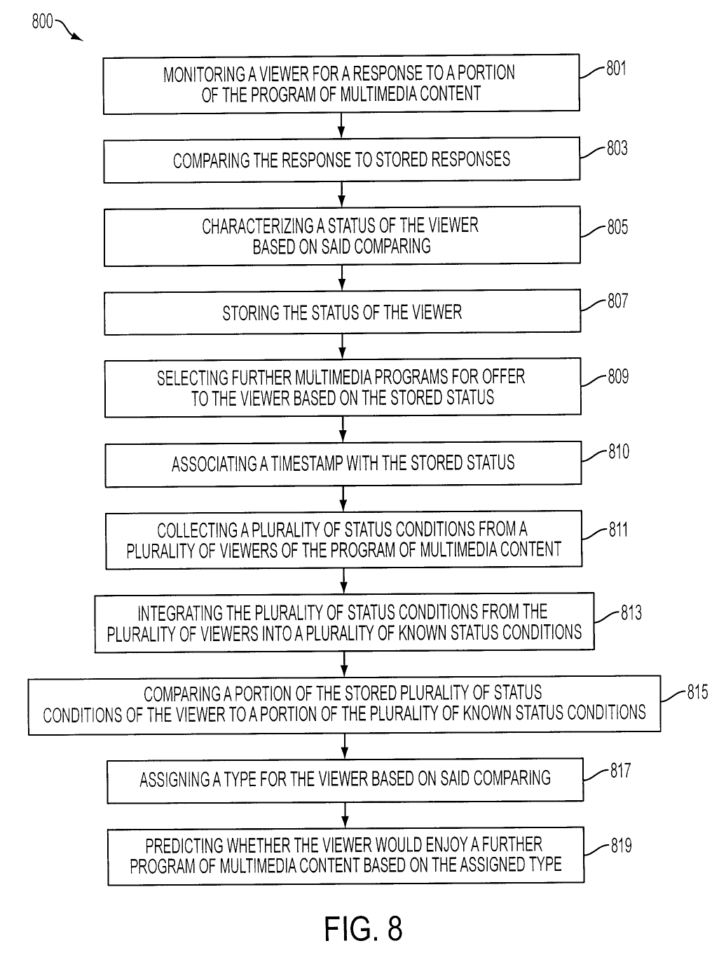

FIG. 8 illustrates an embodiment of a disclosed method 800. As shown, the method includes monitoring (operation 801) a viewer for a response to a portion of a multimedia program. Viewer responses are compared (operation 803) to stored responses. Stored responses may originate from developers or may be accumulated from observing and processing data from other viewers of the multimedia program. The status of the viewers is characterized (operation 805) based on comparing and the status of the viewer is stored (operation 807). Further multimedia programs may be selected (operation 809) for offer to the viewer based on the stored status of the viewer. For example, if a viewer is deemed to be happy during a certain portion of a comedy multimedia program, other comedy programs with similar humor may be offered to the viewer. A timestamp may be associated (operation 810) with the stored status. For example, a viewer status may be “happy” at one hour and 15 minutes into the program. If it is known that a slap-stick humor scene occurs in the multimedia program at one hour 15 minutes into the program, the viewer status of happy at the corresponding time indicates that the viewer enjoyed the slap-stick humor scene. A plurality of status conditions is collected (operation 811) from a plurality of viewers of the program of multimedia content. This may include collecting reaction information from viewers that are geographically remote from one another, that are in the same viewing area, or both. The plurality of status conditions may be integrated (operation 813) into a plurality of known status conditions. For example, if 90% of viewers are deemed to be happy one hour, 10 minutes, and 17 seconds into the program, a known status condition may be stored of 0.9, which indicates a 90% probability that the viewer that is being monitored for viewer reactions should be happy at that time. Similarly, other known status conditions may be stored at other times. Other known status conditions may be associated with laughing, cheering, smiling, or a gaze status. A viewer's reaction may be compared against these known conditions and a viewer type may be determined from the comparisons. In the alternative, a viewer's reaction may be determined and may be used for determining, for example, marketing revenue that is calculated based on the number of viewers that are viewing a particular advertisement. A type is assigned (operation 817) for the viewer based on the comparing. Disclosed systems predict (operation 819) whether the viewer would enjoy other multimedia programs based on the assigned type. For example, if a viewer is determined to be an Oilers fan, future Oilers games that are shown on pay-per-view may be offered within special advertisements provided to the viewer.

While the disclosed subject matter has been described in connection with one or more embodiments, the disclosed embodiments are not intended to limit the subject matter of the claims to the particular forms set forth. On the contrary, disclosed embodiments are intended to encompass alternatives, modifications, and equivalents.

What is claimed is:

1. A method of mining viewer responses to a program of multimedia content, the method comprising:
monitoring a viewer for a response to a portion of the program of multimedia content;
comparing the response to stored responses;
characterizing a status of the viewer based on said comparing; and
storing the status of the viewer.

2. The method of claim 1, further comprising:
selecting further multimedia programs for offer to the viewer based on the stored status.

3. The method of claim 1, further comprising:
associating a timestamp with the stored status.

4. The method of claim 1, further comprising:
collecting a plurality of status conditions from a plurality of viewers of the program of multimedia content; and
integrating the plurality of status conditions from the plurality of viewers into a plurality of known status conditions.

5. The method of claim 4, wherein said storing the status includes storing a plurality of status conditions of the viewer at a plurality of portions of the program, wherein the method further comprises:
comparing a portion of the stored plurality of status conditions of the viewer to a portion of the plurality of known status conditions; and
assigning a type for the viewer based on said comparing.

6. The method of claim 5, further comprising:
predicting whether the viewer would enjoy a further program of multimedia content based on the assigned type.

7. The method of claim 6, wherein said monitoring includes:
monitoring the viewer for a gaze status, wherein a gaze status is indicative of a level of eye movement; and
estimating whether the viewer is paying attention to the program based on the gaze status.

8. The method of claim 1, further comprising:
generating video data from a plurality of video images of the viewer; and
wherein said characterizing is further based on comparing the video data to predetermined video parameters.

9. The method of claim 8:
wherein said comparing of the video data includes analyzing the video data to determine whether the viewer is smiling or laughing.

10. The method of claim 8, further comprising:
wherein said comparing of the video data includes analyzing the video data to determine whether the viewer is facing a display on which the program of multimedia content is presented.

11. The method of claim 8, further comprising:
analyzing the video data to track a color-coded implement that may be moved by the viewer.

12. The method of claim 11, wherein the color-coded implement is a glove.

13. The method of claim 1, wherein said monitoring includes generating audio data from a plurality of audio signals captured from a location local to the viewer, and wherein said characterizing is further based on a comparing of the audio data to predetermined audio parameters to characterize the status of the viewer.

14. The method of claim 13, wherein a portion of the plurality of audio signals are generated using bone conduction microphones.

15. The method of claim 13, further comprising:
estimating whether the viewer has a vocal outburst to a portion of the program of multimedia content by detecting magnitude changes in the audio signals.

16. The method of claim 13, the method further comprising:
generating motion data from said monitoring; and
wherein said characterizing is further based on a comparing of the motion data to predetermined motion parameters.

17. The method of claim 1, further comprising:
capturing biometric data indicative of a biometric parameter of the viewer;
comparing the biometric data to predetermined biometric norms; and
wherein said characterizing is further based on said comparing of the biometric data.

18. The method of claim 17, wherein said capturing includes capturing data indicative of a pulse rate of the viewer.

19. The method of claim 18, wherein said capturing includes capturing temperature data indicative of a temperature of the viewer.

20. The method of claim 18, wherein said capturing includes capturing data from a subdermal transducer.

21. A computer program product stored on at least one computer readable media, the computer program product for characterizing a viewer response to a multimedia content program, the computer program product comprising instructions for:
detecting a viewer response to a portion of the multimedia content program using data captured from transducers that are placed within a viewing area that is proximal to the viewer;
comparing the viewer response to stored responses;
characterizing a status of the viewer based on said comparing; and
storing the status of the viewer.

22. The computer program product of claim 21, further comprising instructions for:
collecting a plurality of status conditions from a plurality of viewers of the multimedia content program; and
integrating the plurality of status conditions from the plurality of viewers into a plurality of known status conditions.

23. The computer program product of claim 21, wherein said storing includes storing a plurality of status conditions at a plurality of portions of the program, wherein the method further comprises:
comparing a portion of the stored plurality of status conditions of the viewer to a portion of the plurality of known status conditions;
assigning a type for the viewer based on said comparing; and
predicting whether the viewer would enjoy a further program of multimedia content based on the assigned type.

24. The computer program product of claim 23, wherein said detecting includes:
monitoring the viewer for a gaze status indicative of a level of eye movement; and
estimating whether the viewer is paying attention to the program based on the gaze status.

25. The computer program product of claim 21, further comprising instructions for:
generating video data from a plurality of video images captured from the viewer;
comparing the video data to predetermined video parameters;
analyzing the video data to determine whether the viewer is smiling or laughing;
analyzing the video data to determine whether the viewer is facing a display on which the program of multimedia content is presented;
generating audio data from a plurality of audio signals captured from a location local to the viewer;
comparing the audio data to predetermined audio parameters;
estimating whether the viewer has a vocal outburst by detecting changes in an audio level measured at the location;
generating motion data from monitoring the viewer;
comparing the motion data to predetermined motion parameters; and
capturing biometric data from the viewer.

26. A device for processing data generated from monitoring a viewer of a multimedia content program to estimate a plurality of reactions from the viewer, the device comprising:
an interface for receiving data from a plurality of transducers in a data collection environment in which the multimedia content program is presented, wherein the data includes:
audio data; and
video data; and
a processor for:
comparing the data to known data and estimating the plurality of reactions;
associating the plurality of reactions with time data; and
estimating whether the viewer would enjoy a further program of multimedia content based on the plurality of reactions.

27. The device of claim 26, wherein the data further includes:
biometric data.

28. The device of claim 27, wherein the biometric data includes pulse data.

29. The device of claim 28, wherein one or more of the plurality of transducers is subdermal.

30. The device of claim 26, wherein a portion of the plurality of transducers uses one or more bone conduction microphones.

31. The device of claim 26, wherein the device comprises customer premises equipment (CPE) suitable for processing the multimedia content program for presentation to a display.

32. The device of claim 31, wherein the CPE comprises a set-top box.
